(19) United States
(12) Patent Application Publication
(10) Pub. No.: US 2021/0078900 A1
(43) Pub. Date: Mar. 18, 2021

(54) GLASS SHEETS WITH IMPROVED EDGE QUALITY AND METHODS OF PRODUCING THE SAME

(71) Applicant: Corning Incorporated, Corning, NY (US)

(72) Inventors: Jiangwei Feng, Painted Post, NY (US); Chia-Yen Pai, Taichung (TW); James Joseph Price, Corning, NY (US); Wanda Janina Walczak, Big Flats, NY (US)

(21) Appl. No.: 16/771,475

(22) PCT Filed: Dec. 10, 2018
(86) PCT No.: PCT/US2018/064762

§ 371 Date: Jun. 10, 2020

Related U.S. Application Data
(60) Provisional application No. 62/597,138, filed on Dec. 11, 2017.

(51) Int. Cl. C03C 23/00; C03B 17/06; C03B 29/10; C03B 33/033

(52) U.S. Cl. CPC C03C 23/006; C03B 33/033; C03B 29/10; C03B 17/067

(57) ABSTRACT

A method of manufacturing and treating a glass article wherein the treatment of the article includes directing a flow of plasma, such as a flow of plasma comprising an atmospheric pressure plasma jet, toward an edge surface of the article. Such treatment can reduce a density of particles on an edge surface of the article. Such treatment can also increase the edge strength of the article.

This application claims the benefit of priority under 35 U.S.C. § 119 of U.S. Provisional Application Ser. No. 62/597,138 filed on Dec. 11, 2017, the content of which is relied upon and incorporated herein by reference in its entirety.

### FIELD

The present disclosure relates generally to glass sheets with improved edge quality and methods for producing the same and more particularly to glass sheets with fewer adhered particles and greater edge strength and methods for producing the same.

### BACKGROUND

In the production of glass articles, such as glass sheets for display applications, including televisions and hand held devices, such as telephones and tablets, there are typically multiple processing steps that can involve glass particle generation, such as when glass sheets are separated from a glass ribbon as well as when the glass sheets are subject to finishing processes, such as edge grinding and polishing. Given that there is a trend for higher resolution displays, it is desirable to minimize the amount of particles present on such articles. Given that there is also a trend for thinner displays, it is also desirable to produce thin glass articles, such as glass sheets, having sufficient mechanical failure resistance.

### SUMMARY

Embodiments disclosed herein include a method for manufacturing a glass article. The method includes forming the glass article, wherein the glass article includes a first major surface, a second major surface parallel to the first major surface, and an edge surface extending between the first major surface and the second major surface in a perpendicular direction to the first and second major surfaces. The method also includes directing a flow of plasma toward the edge surface, wherein direction of the flow of plasma toward the edge surface reduces a density of particles on the edge surface to less than about 40 per 0.1 square millimeter.

Embodiments disclosed herein also include a method for treating a glass article, the glass article including a first major surface, a second major surface parallel to the first major surface, and an edge surface extending between the first major surface and the second major surface in a perpendicular direction to the first and second major surfaces. The method includes directing a flow of plasma toward the edge surface, wherein direction of the flow of plasma toward the edge surface reduces a density of particles on the edge surface to less than about 40 per 0.1 square millimeter.

Embodiments disclosed herein also include a glass article that includes a first major surface, a second major surface parallel to the first major surface, and an edge surface extending between the first major surface and the second major surface in a perpendicular direction to the first and second major surfaces, wherein a density of particles on the edge surface is less than about 40 per 0.1 square millimeter.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic side view of a stage of an example glass sheet separation process;

FIG. 3 is a schematic side view of another stage of an example glass sheet separation process;

FIG. 4 is a schematic side view of yet another stage of an example glass sheet separation process;

FIG. 5 is a schematic side view of still yet another stage of an example glass sheet separation process;

FIG. 6 is an perspective view of a glass sheet;

FIG. 7 is a perspective view of at least a portion of a beveling process of an edge surface of a glass sheet;

FIG. 8 is a perspective view of at least a portion of an edge treatment process with a plasma jet;

FIGS. 9A and 9B are scanning electron microscope (SEM) images of an edge surface of a glass sheet before and after plasma jet treatment, wherein an edge beveling step was not performed prior to the plasma jet treatment;

FIGS. 10A and 10B are SEM images of an edge surface of a glass sheet before and after plasma jet treatment, wherein an edge beveling step was performed prior to the plasma jet treatment;

FIG. 11 is a schematic side cutaway view of an edge region of a glass sheet, wherein the edge region was generated from a score and break process and topographical features of the edge region have been exaggerated for illustrative purposes; and

FIG. 12 is a schematic perspective view of a portion of the edge region illustrated in FIG. 11.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “plasma” refers to an ionized gas comprising positive ions and free electrons.

As used herein, the term “atmospheric pressure plasma jet” refers to a flow of plasma discharged from an aperture, wherein the plasma pressure approximately matches that of the surrounding atmosphere, including conditions wherein the plasma pressure is between 90% and 110% of 101.325 kilopascals (standard atmospheric pressure).

As used herein, the term “particles” refers to any type of particles that can be present on a surface, such as glass particles and dust particles.

As used herein, the term, “edge strength, as measured by the four point bend test”, refers to edge strength at which 10% of samples would be expected to fail using the glass flexure fixture four point test set forth in JIS R1601.

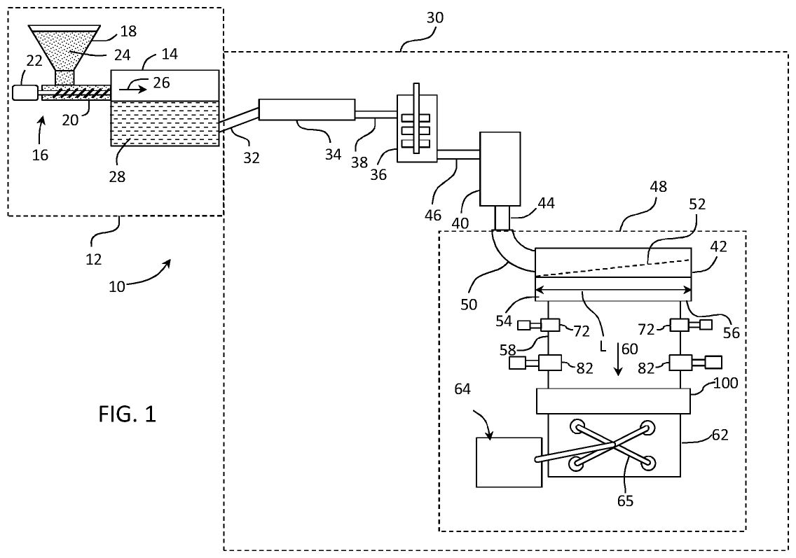

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

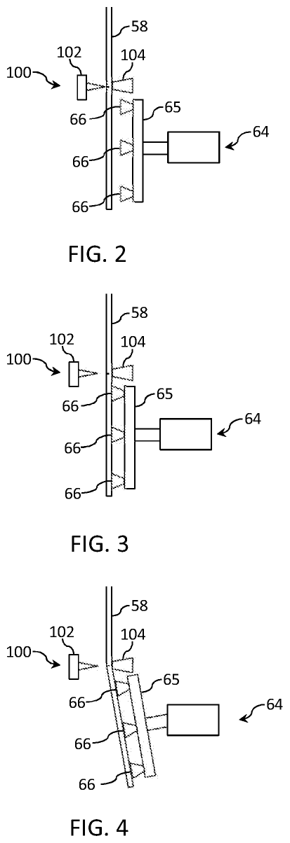

FIG. 2 shows a schematic side view of a stage of an example glass sheet separation process. As shown in FIG. 2, glass separation apparatus 100 includes scoring mechanism 102 and nosing 104, wherein scoring mechanism 102 and nosing 104 are positioned on opposite sides of glass ribbon 58. In the stage shown in FIG. 2, scoring mechanism 102 moves across the glass ribbon 58 in the widthwise direction and imparts a widthwise score line across the glass ribbon 58. In addition, in the stage shown in FIG. 2, gripping tool 65 has not yet engaged glass ribbon 58, although engagement while scoring is also known in the art and commonly practiced.

While scoring mechanism 102 is shown in FIG. 2 as a mechanical scoring mechanism, such as a mechanism comprising a score wheel, it is to be understood that embodiments herein include other types of scoring mechanism, such as, for example, laser scoring mechanisms. When scoring mechanism 102 comprises a score wheel, the score wheel may be mounted on a ball bearing pivot which is secured to a shaft which is in turn mounted on a linear actuator (air cylinder) that moves the score wheel towards the glass ribbon 58 so it can be drawn across and score a side of the ribbon.

Nosing 104 may comprise a resilient material, such as silicon rubber. In certain exemplary embodiments, nosing 104 may be a conformable nosing that has a bowed shape of the glass ribbon 58 as disclosed, for example, in U.S. Pat. No. 8,051,681, the entire disclosure of which is incorporated by reference. Nosing 104 may also be in fluid communication with a vacuum source (not shown) to enhance engagement between the glass ribbon 58 and the nosing, as disclosed, for example, in U.S. Pat. No. 8,245,539, the entire disclosure of which is incorporated herein by reference.

FIG. 3 shows a schematic side view of another stage of an example glass sheet separation process wherein scoring mechanism 102 has disengaged glass ribbon 58 and gripping tool 65, including gripping elements 66, is actuated by robot 64 to engage glass ribbon 58. Gripping elements 66 may, for example, comprise a resilient material, such as silicone rubber, and may, in certain exemplary embodiments, comprise a cup-shaped resilient material that may be in fluid communication with a vacuum source (not shown) to enhance engagement between the glass ribbon 58 and the gripping elements 66 (gripping elements comprising cup-shaped material in fluid communication with a vacuum source are hereinafter referred to as vacuum cups).

As shown in FIG. 3, while the gripping tool 64, including gripping elements 66, imparts a pulling force on glass ribbon 58, the pulling force is not sufficient to substantially bend the glass ribbon 58 away from the draw or flow direction 60. FIG. 4, however, shows a schematic side view of yet another stage of an example glass sheet separation process wherein gripping tool 65 has been further actuated by robot 64, thereby imparting a pulling force that is sufficient to begin to bend the portion of glass ribbon 58 extending below nosing 104 away from the draw or flow direction 60. However, as shown in FIG. 4, the pulling force is not yet sufficient to substantially separate the portion of the glass ribbon 58 extending below nosing 104 from the rest of the glass ribbon 58.

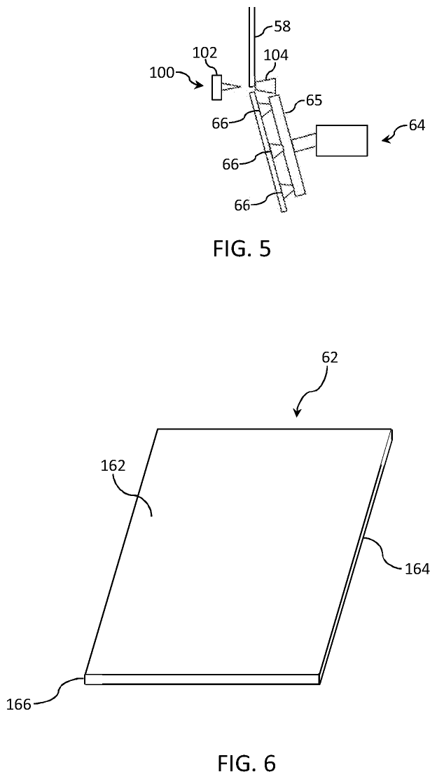

FIG. 5 shows a schematic side view of still yet another stage of an example glass sheet separation process wherein gripping tool 65 has been further actuated by robot 65, thereby imparting a pulling force that is sufficient to separate the portion of the glass ribbon 58 extending below nosing 104 (i.e., glass sheet) from the rest of the glass ribbon 58. The glass sheet may then be transferred to, for example, a conveyor system for further processing.

FIG. 6 shows a perspective view of a glass sheet 62 having a first major surface 162, a second major surface 164 extending in a generally parallel direction to the first major surface (on the opposite side of the glass sheet 62 as the first major surface) and an edge surface 166 extending between the first major surface and the second major surface and extending in a generally perpendicular direction to the first and second major surfaces 162, 164.

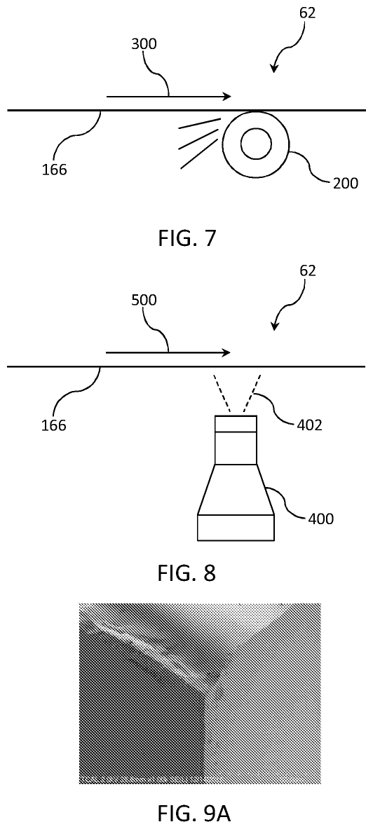

FIG. 7 shows a perspective view of at least a portion of a beveling process of an edge surface 166 of a glass sheet 62. As shown in FIG. 7, beveling process includes applying a grinding wheel 200 to edge surface 166, wherein the grinding wheel 200 moves relative to edge surface 166 in the direction indicated by arrow 300. Beveling process may further include applying at least one polishing wheel (not shown) to edge surface 166. Such beveling process can lead to the presence of numerous glass particles, as well as surface and sub-surface damage (i.e., irregular topography), on edge surface 166.

Downstream processing of glass sheet 62 may involve application of mechanical or chemical treatments on edge surfaces 166, which can result in additional particle generation due to the presence of irregular edge surface topography. Such particles may migrate to at least one surface of glass sheets 62. Accordingly, embodiments disclosed herein include those in which irregular edge surface topography is removed, while at the same time removing and/or reducing particles present on the edge surfaces 166 (i.e., “edge particles”) as well as removing reaction by-products that may be formed upon removal of the irregular edge surface topography.

FIG. 8 shows a perspective view of at least a portion of a treatment process of an edge surface 166 of a glass sheet 62 with a plasma jet 402. As shown in FIG. 8, treatment process includes directing a flow of plasma, via plasma jet 402, toward edge surface 166, wherein plasma jet head 400 moves relative to edge surface 166 in the direction indicated by arrow 500. In certain exemplary embodiments, plasma jet 402 comprises an atmospheric pressure plasma jet.

Plasma jet 402 can be directed toward edge surface 166 under a variety of processing parameters. In certain exemplary embodiments, plasma jet 402 can be generated at a power of at least about 300 watts, such as a power of at least about 500 watts, including a power of from about 300 watts to about 800 watts and further including a power of from about 500 watts to about 800 watts.

In certain exemplary embodiments, plasma jet 402 is generated via a direct current high voltage discharge that generates a pulsed electric arc, such as a voltage discharge of at least about 5 kV, such as from about 5 kV to about 15 kV. In certain exemplary embodiments, plasma jet 402 is generated at a frequency of at least about 10 kHz, such as from about 10 kHz to about 100 kHz. In certain exemplary embodiments, plasma jet can have a beam length of from about 5 millimeters to about 40 millimeters and a widest beam width of from about 0.5 millimeters to about 15 millimeters.

In certain exemplary embodiments, the distance between the portion of plasma jet head 400 that is closest to edge surface 166 (referred to herein as “gap distance”), is at least about 1 millimeter, such as at least about 2 millimeters, and further such as at least about 4 millimeters, and yet further such as at least about 5 millimeters, such as from about 1 millimeter to about 10 millimeters, including from about 5 millimeters to about 10 millimeters.

In certain exemplary embodiments, the speed of relative movement between plasma jet head 400 and edge surface 166 (referred to herein as “scan speed”) can range from about 1 millimeter per second to about 50 millimeters per second, such as from about 5 millimeters per second to about 25 millimeters per second, and further such as from about 10 millimeters per second to about 20 millimeters per second.

In certain exemplary embodiments, the number of times that the plasma jet head 400 moves relative to the entire length of edge surface 166 (referred to herein as “scan pass”) can be at least 1 pass, such as at least 2 passes, and further such as at least 3 passes, and yet further such as at least 4 passes, including from 1 pass to 10 passes, and further including from 2 passes to 6 passes.

In certain exemplary embodiments, the plasma comprises at least one component selected from the group consisting of nitrogen, argon, oxygen, hydrogen, and helium that is excited and at least partially converted to the plasma state. In certain exemplary embodiments, the plasma comprises at least one component selected from the group consisting of nitrogen, argon, and hydrogen, such as at least two components selected from the group consisting of nitrogen, argon, and hydrogen, and further such as embodiments in which the plasma comprises each of nitrogen, argon, and hydrogen. When the plasma comprises at least one of nitrogen, argon, and hydrogen, the nitrogen content can, for example, range from about 50 mol % to about 100 mol %, such as from about 60 mol % to about 90 mol %, the argon content can, for example, range from about 0 mol % to about 20 mol %, such as from about 5 mol % to about 15 mol %, and the hydrogen content can, for example, range from about 0 mol % to about 10 mol %, such as from about 1 mol % to about 5 mol %.

In certain exemplary embodiments, treatment process comprising directing a flow of plasma, via plasma jet 402, toward edge surface 166, can result in a substantial reduction of particle density on edge surface 166, such as a particle density reduction of at least 1 order of magnitude, and further such as a particle density reduction of at least 2 orders of magnitude, and yet further such as a particle density reduction of at least 3 orders of magnitude. For example, directing a flow of plasma toward edge surface 166, according to embodiments disclosed herein, can reduce a density of particles on edge surface 166 to less than about 40 per 0.1 square millimeter, such as less than about 30 per 0.1 square millimeter, and further such as less than about 20 per 0.1 square millimeter, and yet further such as less than about 10 per 0.1 square millimeter, including from about 0 to about 40 particles per 0.1 square millimeter, and further including from about 1 to about 30 particles per 0.1 square millimeter, and yet further from about 2 to about 20 particles per 0.1 square millimeter.

In certain exemplary embodiments, treatment process comprising directing a flow of plasma, via plasma jet 402, toward edge surface 166, can result in an edge strength subsequent to directing a flow of plasma toward the edge surface, as measured by the four point bend test, of at least about 130 MPa, such as at least about 150 MPa, and further such as at least about 200 MPa. For example, in certain embodiments, the distance of the extension direction of the edge between the first and second major surfaces (i.e., the thickness of glass sheet 62) is less than or equal to about 0.5 millimeters and treatment process comprising directing a flow of plasma, via plasma jet 402, toward edge surface 166, can result in an edge strength subsequent to directing a flow of plasma toward the edge surface, as measured by the four point bend test, of at least about 130 MPa, such as at least about 150 MPa, and further such as at least about 200 MPa.

Embodiments disclosed herein include those in which plasma jet 402 is applied toward edge surface 166 after or in lieu of an edge beveling process, such as the exemplary edge beveling process shown in FIG. 7. For example, in certain exemplary embodiments, plasma jet 402 may be applied toward edge surface 166 of glass sheet 62 immediately following separation of glass sheet 62 from glass ribbon 58, as shown, for example, in FIG. 5. Alternatively, subsequent processing steps, such as the exemplary edge beveling process shown in FIG. 7, may be applied to glass sheet 62, prior to application of plasma jet 402 toward edge surface 166 of glass sheet 62.

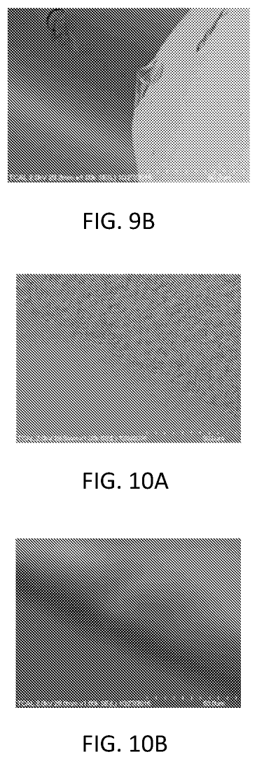

FIGS. 9A and 9B show SEM images of an edge surface of a glass sheet before and after plasma jet treatment, wherein an edge beveling step, such as the exemplary edge beveling process shown in FIG. 7, was not performed prior to the plasma jet treatment. In particular, the edge surface shown in FIGS. 9A and 9B, was generated as the result of separation of a glass sheet from a glass ribbon using a score and break process similar to the process exemplified in FIGS. 2-5. Then, the edge surface was treated with an atmospheric pressure plasma jet in accordance with embodiments disclosed herein. As can be seen from comparing FIG. 9A to FIG. 9B, the treated edge exhibited substantially smoother surface topography.

FIGS. 10A and 10B show SEM images of an edge surface of a glass sheet before and after plasma jet treatment, wherein an edge beveling step, such as the exemplary edge beveling process shown in FIG. 7, was performed prior to the plasma jet treatment. In particular, subsequent to the edge beveling process, the edge surface was treated with an atmospheric pressure plasma jet in accordance with embodiments disclosed herein. As can be seen from comparing FIG. 10A to FIG. 10B, the treated edge exhibited substantially smoother surface topography.

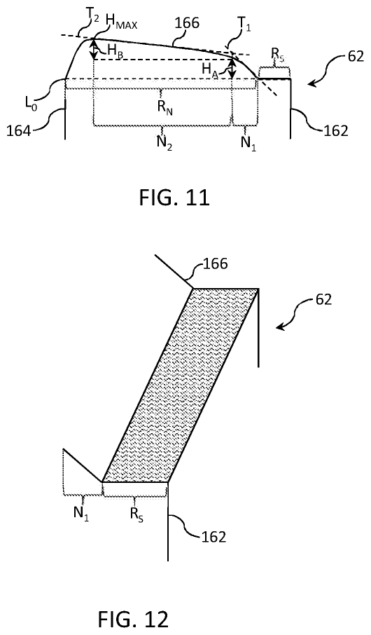

FIG. 11 shows a schematic side cutaway view of an edge region of a glass sheet, wherein the edge region was generated from a score and break process and topographical features of the edge region have been exaggerated for illustrative purposes. In particular, edge surface 166 of glass sheet 62 was generated by a score and break process similar to the process exemplified in FIGS. 2-5 that included applying a scoring mechanism to a glass ribbon in order to impart a score line across the glass ribbon in the widthwise direction (as shown, for example, in FIG. 2) and imparting a pulling force sufficient to separate the glass sheet 62 from the scored glass ribbon (as shown, for example, in FIGS. 3-5).

As shown in FIG. 11, edge surface 166 deviates from a line, L₀, extending in a perpendicular direction to the first major surface 162 and the second major surface 164 of glass sheet 62. In particular, prior to directing a flow of plasma toward edge surface 166, edge surface 166 comprises a scored region, R_{S}, extending between the first major surface 162 and the depth of the score line, and a non-scored region, R_{N}, extending between the depth of the score line and the second major surface 164.

More particularly, non-scored region, R_{N}, comprises a first surface region, N₁, having an average slope parallel to first tangent line, T₁, and a second surface region, N₂, having an average slope parallel to second tangent line, T₂. As shown in FIG. 11, T₁>T₂ and the first surface region, N₁, extends between the depth of the score line and a crossing point of T₁ and T₂ and the second surface region, N₂, extends between the crossing point of T₁ and T₂ and a highest point, H_{MAX}, of the non-scored region, R_{N} (the highest point, H_{MAX}, of the non-scored region is the point where the linear distance between edge surface 166 and L₀ is the greatest).

Embodiments disclosed herein include those in which a depth of the score line in a thickness direction of the glass ribbon (i.e., the widthwise score line that is shown, for example, in FIG. 2) ranges from about 7% to about 10% of a thickness of the glass ribbon, which, in turn, results in an edge surface 166 comprising a scored region, R_{S}, such as that shown in FIG. 11, that extends from about 7% to about 10% of the thickness of the glass sheet 62 (i.e., the scored region, R_{S}, extends from about 7% to about 10% of the distance of the extension direction of the edge between the first major surface 162 and the second major surface 164 and the non-scored region, R_{N}, extends from about 90% to 93% of the distance of the extension direction of the edge between the first major surface 162 and the second major surface 164).

Applicants have found that when the scoring is controlled such that a depth of the score line ranges from about 7% to about 10% of a thickness of a glass ribbon, a topography can be achieved, following a score and break process, wherein a maximum height difference, H_{A}, between the highest and lowest points of the first surface region, N₁, is less than or equal to 2 microns, such as from 0.2 microns to 2 microns, and a maximum height difference, H_{B}, between the highest and lowest points of the second surface region, N₂, is less than or equal to 10 microns, such as from 1 micron to 10 microns. As, shown in FIG. 11, the highest point of a specified region is the point where the linear distance between edge surface 166 and L₀ is the greatest within that region and the lowest point of a specified region is the point where the linear distance between edge surface 166 and L₀ is the smallest within that region, with H_{A} representing the liner difference between the highest and lowest points of N₁ and H_{B} representing the linear difference between the highest and lowest points of N₂.

Applicants have further found that when the above topography is achieved (i.e., wherein H_{A} is less than or equal to 2 microns and H_{B} is less than or equal to 10 microns), improvement of edge quality following treatment of edge surface 166 with plasma can be achieved, particularly with respect to improvement in edge strength, which, in turn, results in the production of glass articles having lower failure probability.

Additional improvement of edge quality may be achieved by controlling scoring parameters such that not only is the above topography achieved but also an arithmetical mean surface roughness, Rₐ, of scored region, R_{S}, of less than or equal to 0.35 microns and a maximum peak, R_{y}, of less than or equal to 4.5 microns. FIG. 12 shows a schematic perspective view of a portion of the edge region of glass article 62 illustrated in FIG. 11, specifically showing scored region, R_{S}, and first surface region, N₁, of edge surface 166. Arithmetical mean surface roughness, Rₐ, and maximum peak, R_{y}, of scored region, R_{S}, can be determined as set forth in JIS B 0031 (1994).

Scoring parameters that can be controlled include not only score line depth, as discussed above, but also consistency of that depth in the widthwise direction, selection of scoring wheel, and selection of scoring force. Control of such parameters can mitigate the generation of lateral cracks during scoring as well as generate crack extensions from the score line with more uniform medium depth. In certain exemplary embodiments, the scoring force can range from about 3 newtons to about 15 newtons, such as from about 5 newtons to about 10 newtons. Non-limiting examples of score wheels that can be used include APIO® and Penett® wheels available from MDI Advanced Processing GmbH.

In certain exemplary embodiments, edge surface 166 may be heated, for example, by an electrical resistance heater or an induction heater, to a temperature of at least about 100° C., such as at least about 200° C., and further such as at least about 300° C., and yet further such as at least about 400° C., and still yet further such as at least about 500° C., including a temperature ranging from about 100° C. to about 600° C. prior to directing the flow of plasma toward the edge surface 166. Exemplary embodiments also include those in which temperature of edge surface 166 is maintained in the above-referenced ranges for a period of time subsequent to directing a flow of plasma toward the edge surface 166. Such heat treatment can potentially reduce edge tensile stress.

### EXAMPLES

Embodiments herein are further illustrated with reference to the following non-limiting examples:

### Example 1

Samples of Eagle XG® glass sheets having a thickness of about 0.5 millimeters and first and second major surface dimensions of about 5 millimeters by about 15 millimeters were subjected to edge treatment by atmospheric pressure plasma jet as set forth in Table 1. The “pre-stress” values reported in the table relate to edge stress present in the sample prior to treatment by atmospheric plasma jet whereas the reported “post-stress” values relate to edge stress present in the sample subsequent to treatment by atmospheric plasma jet. Both the “pre-stress” and “post-stress” values were determined by an optical birefringence method. Edge surface article density, as reported in Table 1, was determined by applying an adhesive surface (e.g., tape) to an edge surface of the sample and then examining the adhesive surface (e.g., tape) under a SEM to count the number of observed particles.

| | | | | | | | Particle |
|---|---|---|---|---|---|---|---|
| Sam- | | Scan | Gap | | Pre- | Post- | density |
| ple | Power | speed | distance | Scan | stress | stress | (#/0.1 |
| No. | (W) | (mm/s) | (mm) | pass | (MPa) | (MPa) | mm²) |
| 1 | 500 | 10 | 5 | 1 | 65 | 23 | 35.7 |
| 2 | 500 | 10 | 6 | 2 | 55 | 21 | 6.36 |
| 3 | 500 | 20 | 5 | 2 | 116 | 24 | 2.31 |
| 4 | 500 | 20 | 6 | 1 | 54 | 9 | 0 |
| 5 | 600 | 10 | 5 | 2 | 60 | 23 | 0.578 |
| 6 | 600 | 10 | 6 | 1 | 54 | 24 | 3.7 |
| 7 | 600 | 20 | 5 | 1 | 112 | 37 | 0.578 |
| 8 | 600 | 20 | 6 | 2 | 112 | 34 | 1.57 |
| 9 | 550 | 15 | 5.5 | 1 | 113 | 35 | 1.57 |
| 10 | 550 | 15 | 5.5 | 2 | 88 | 30 | 8.10 |

As can be seen from Table 1, atmospheric plasma jet treatment lowered the stress levels in the samples. In addition, the edge surface particle densities reported in Table 1 represent a particle density reduction of approximately one to three orders of magnitude when compared to untreated samples produced by a similar manufacturing process. The samples reported in Table 1 would also generally be expected to have an edge strength that is at least 30 MPa greater, such as at least 50 MPa greater, and further such as at least 100 MPa greater than an edge strength of untreated samples produced by a similar manufacturing process. Such increased edge strength reduces the probability of glass breakage during assembly or usage of, e.g., electronic devices comprising the glass.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. A method for manufacturing a glass article comprising:
forming the glass article, wherein the glass article comprises a first major surface, a second major surface parallel to the first major surface, and an edge surface extending between the first major surface and the second major surface in a perpendicular direction to the first and second major surfaces; and
directing a flow of plasma toward the edge surface, wherein direction of the flow of plasma toward the edge surface reduces a density of particles on the edge surface to less than about 40 per 0.1 square millimeter.

2. The method of claim 1, wherein the flow of plasma comprises an atmospheric pressure plasma jet.

3. The method of claim 1, wherein a distance of the extension direction of the edge between the first and second major surfaces is less than or equal to about 0.5 millimeters and an edge strength of the glass article subsequent to directing a flow of plasma toward the edge surface, as measured by the four point bend test, is at least about 130 MPa.

4. The method of claim 1, wherein the plasma is generated at a power of at least about 300 watts.

5. The method of claim 1, wherein the plasma comprises at least one component selected from the group consisting of nitrogen, argon, oxygen, hydrogen, and helium.

6. The method of claim 1, wherein the edge surface is heated to a temperature of at least about 100° C. prior to directing the flow of plasma toward the edge surface.

7. The method of claim 1, wherein the step of forming the glass article comprises separating a glass sheet from a glass ribbon by:
applying a scoring mechanism to the glass ribbon in order to impart a score line across the glass ribbon in the widthwise direction; and
imparting a pulling force sufficient to separate the glass sheet from the scored glass ribbon;
wherein a depth of the score line in a thickness direction of the glass ribbon ranges from about 7% to about 10% of a thickness of the glass ribbon.

8. The method of claim 7, wherein, prior to directing a flow of plasma toward the edge surface, the edge surface comprises a scored region, R_{S}, extending between the first major surface and the depth of the score line, and a non-scored region, R_{N}, extending between the depth of the score line and the second major surface.

9. The method of claim 8, wherein the non-scored region, R_{N}, comprises a first surface region, N₁, having an average slope parallel to first tangent line, T₁, and a second surface region, N₂, having an average slope parallel to second tangent line, T₂, wherein T₁>T₂ and the first surface region, N₁, extends between the depth of the score line and a crossing point of T₁ and T₂ and the second surface region, N₂, extends between the crossing point of T₁ and T₂ and a highest point, H_{MAX}, of the non-scored region, R_{N}.

10. The method of claim 9, wherein a maximum height difference, H_{A}, between the highest and lowest points of the first surface region, N₁, is less than or equal to 2 microns and a maximum height difference, H_{B}, between the highest and lowest points of the second surface region, N₂, is less than or equal to 10 microns.

11. The method of claim 7, wherein the scored region, R_{S}, has an arithmetical mean surface roughness, Rₐ, of less than or equal to 0.35 microns and a maximum peak, R_{y}, of less than or equal to 4.5 microns.

12. A method for treating a treating a glass article, the glass article comprising:
a first major surface, a second major surface parallel to the first major surface, and an edge surface extending between the first major surface and the second major surface in a perpendicular direction to the first and second major surfaces;
wherein the method comprises directing a flow of plasma toward the edge surface, wherein direction of the flow of plasma toward the edge surface reduces a density of particles on the edge surface to less than about 40 per 0.1 square millimeter.

13. The method of claim 12, wherein the flow of plasma comprises an atmospheric pressure plasma jet.

14. The method of claim 12, wherein a distance of the extension direction of the edge between the first and second major surfaces is less than or equal to about 0.5 millimeters and an edge strength of the glass article subsequent to directing a flow of plasma toward the edge surface, as measured by the four point bend test, is at least about 130 MPa.

15. The method of claim 12, wherein the plasma is generated at a power of at least about 300 watts.

16. The method of claim 12, wherein the plasma comprises at least one component selected from the group consisting of nitrogen, argon, oxygen, hydrogen, and helium.

17. The method of claim 12, wherein the edge surface is heated to a temperature of at least about 100° C. prior to directing the flow of plasma toward the edge surface.

18. A glass article comprising a first major surface, a second major surface parallel to the first major surface, and an edge surface extending between the first major surface and the second major surface in a perpendicular direction to the first and second major surfaces, wherein a density of particles on the edge surface is less than about 40 per 0.1 square millimeter.

19. The glass article of claim 18, wherein a distance of the extension direction of the edge between the first and second major surfaces is less than or equal to about 0.5 millimeters and an edge strength of the glass article, as measured by the four point bend test, is at least about 130 MPa.

20. (canceled)

21. An electronic device comprising the glass article of claim 18.
